(19) United States
(12) Patent Application Publication
(10) Pub. No.: US 2008/0294796 A1
(43) Pub. Date: Nov. 27, 2008

(54) Native Language Internet Address System

(75) Inventors: Pan Jung Lee, Seoul (KR); Jeen Hyun Bae, Seoul (KR); Suk Moon Lee, Seoul (KR); Jong Ho Won, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: Netpia.com, Inc., Youngdeunpo-Gu (KR)

(21) Appl. No.: 11/628,347

(22) PCT Filed: Jun. 3, 2005
(86) PCT No.: PCT/KR05/01679

§ 371 Date: Jun. 26, 2008

(30) Foreign Application Priority Data
Jun. 4, 2004 (KR) 10-2004-0040923

(51) Int. Cl. G06F 15/16

(52) U.S. Cl. 709/245

(57) ABSTRACT

A native language Internet address system is provided. The native language Internet address system can accommodate data of various language and regions, be written in Unicode, and process various letters of the world unlike an existing hierarchical domain written in Letter, Digit, and Hyphen (LDH). Further, a single system is provided which incorporates native language Internet addresses of the world to provide service.

### TECHNICAL FIELD

The present invention relates to native language Internet address systems, and more particularly, to a native language Internet address system capable of indicating data that enables access to a specific resource by using a keyword that can be written in the language of respective regions.

### BACKGROUND ART

The Internet is not a simple collection of several computers but a huge network built by interconnecting different types of computer networks. Each computer on the Internet is assigned a physical address, i.e., an Internet protocol (IP) address, for identification purposes.

The physical address includes four groups each consisting of digits no more than 255 (e.g., 134.78.238.99). It is very difficult for a user to memorize such a string of digits. In addition, it is troublesome for a user to enter such an IP address whenever he or she accesses a specific computer on the Internet.

For these reasons, it is common for a physical IP address not to be used to access a computer, and a user is automatically connected to a computer having the IP address by entering a string of letters corresponding to the IP address. Such a combination of letters used instead of the IP address is called a domain name.

Meanwhile, when a domain is registered through a provider that provides widely used web hosting service, i.e., a service allowing a user having no host computer to register his or her domain name, one or more domain names may correspond to one IP address.

The domain name is an address of a computer on the Internet and generally has an identifier indicating features and geographical position of the computer. For example, “ABC.co.kr” of james@ABC.co.kr, which is an e-mail address, is a substantial domain name. “ABC.co.kr” of http://www.ABC.co.kr, which is a URL uniform resource location that is based on an IP address system, is a substantial domain name. In a URL such as “http//www.internic.net/index.html” that is an address provided to a computer on the Internet, “internic.net” is a domain name and “index.html” is a file name containing a directory storing corresponding information.

In order to use a domain name, a separate device is required which has a function of associating an IP address of a computer with the domain name. With this requirement, respective computers on the Internet are associated with a computer system that performs such a function, i.e., a domain name server (DNS).

In general, when a client desiring to access a specific computer on the Internet requests a domain name server to confirm an IP address corresponding to a domain name of the computer, e.g., “def.co.kr”, the domain name server enquires about an IP address corresponding to a domain name of a server of a registration authority managing IP addresses, receives the IP address from the server of the registration authority, and returns the IP address to the client, such that the client connects to the computer having the IP address. As described above, a user desiring to access a specific computer on the Internet should know the domain name of the computer. It is, however, relatively difficult for users in non-English-speaking countries such as Korea, Japan, China, etc. to memorize the domain name, compared to users in English-speaking countries, since the domain name is a combination of English letters made according to certain rules.

Methods of allowing users of non-English-speaking countries to access web pages using a domain name written in their own language so that they can conveniently use the Internet have been studied but do not provide a way to easily distinguish non-English languages.

More specifically, because respective languages use the same code by standards of the corresponding country even though the languages are coded and used according to each of the standards, existing domain name servers are unable to determine which standard the non-English languages are coded based on, i.e., which countries languages they are.

There have been attempts to solve such problems. One is disclosed in Korean Laid-open Publication No. 2001-44033, entitled “System and Method for Accessing a Web Page Using Multi-Languages”, filed by the present applicant. When a client-input connection word is written in a language other than English (hereinafter, native language), a native language server provides an IP address of a discrimination server that performs a language discrimination operation. The discrimination server identifies a language representing the client-input connection word by parsing a pattern of the connection word or extracting information on a connection word code standard from the client-input information, and provides the connection word to an access server that processes the language according to the discrimination result, such that the client accesses a web page corresponding to the connection word.

However, this scheme is used to process a connection word written in other languages in one country and is difficult to apply to a structure in which native language Internet address service systems throughout the world cooperate.

Further, one service provider is required to build systems based on other languages. Accordingly, there is need for a system that incorporates and cooperates with systems of different countries built by different service providers.

Also, since efficient service with regard to multi-lingual countries and languages used in more than one country, etc. cannot be provided by convention technology, there is a need for a new system.

### DISCLOSURE OF INVENTION

### Technical Problem

In order to solve the foregoing and/or other problems, it is an aspect of the present invention to provide a native language internet address system capable of indicating data that enables access to a specific resource by using a keyword which is possibly denoted in languages of respective countries differently from the domain which is hierarchical structure consisting of LDH (Ascii, digit, hyphen).

It is another aspect of the present invention to provide the native language internet address system which is able to contain of diverse languages and regional data, and which can process diverse characters denotable in Unicode, and to incorporate all native language Internet addresses in the world into one system to provide service.

It is still another aspect of the present invention to provide a native language Internet address service even though a native language is input to any system in the world by clustering the systems in cooperation with native language Internet address systems.

### Technical Solution

According to a first aspect of the present invention, a native language Internet address system includes: a native language Internet address database server for receiving and storing native language Internet address data; a native language Internet address registration module connected to the native language Internet address database server for registering the native language Internet address data; and a native language Internet address server connected to the native language Internet address database server for identifying a language representing a query input by a client, wherein the native language Internet address server fetches a URI or URL address corresponding to a native language from the native language Internet address database server when the input query is written in the native language, and fetches a corresponding URI or URL address in cooperation with a native language Internet address system of another region when the input query is written in a language of another region.

According to a second aspect of the present invention, a native language Internet address system includes: a native language Internet address database server for receiving and storing native language Internet address data classified by languages; a native language Internet address registration module connected to the native language Internet address database server for registering the native language Internet address data; and a native language Internet address server connected to the native language Internet address database server for identifying a language representing a query input by a client, wherein the native language Internet address server identifies a type of a language representing an input query and fetches a corresponding URI or URL address from a native language Internet address database server corresponding to the language, and the native language Internet address database server is updated in cooperation with a native language Internet address database server of a native language Internet address system in each region.

According to a third aspect of the present invention, each native language Internet address system classified by languages and connected to a central native language Internet address database server comprising a native language Internet address database server in each region, includes: a native language Internet address registration module connected to the central native language Internet address database server for registering native language Internet address data of its region; and a native language Internet address server connected to the central native language Internet address database server for sending a query input by a client to the central native language Internet address database server and receiving a corresponding URI or URL address from the central native language Internet address database server, wherein the central native language Internet address database server identifies a type of a language representing an input query and retrieves a URI or URL address corresponding to the language.

According to a fourth aspect of the present invention, each native language Internet address system classified by languages and connected to a central native language Internet address database server comprising a native language Internet address database server in each region, includes: the native language Internet address database server of the region comprised in the central native language Internet address database server; and a native language Internet address registration module for registering native language Internet address data of the region, wherein Each of native language Internet address systems is connected to the central native language Internet address database server for identifying a type of language representing a query input by a client, sending the query to a native language Internet address database server in the region when the query is in the region, sending the query to the central native language Internet address database server when the query is not in the region, and fetching a corresponding URI or URL address.

According to a fifth aspect of the present invention, a central native language Internet address database server for use in a native language Internet address system, includes: a native language Internet address registration module for registering native language Internet address data; and a native language Internet address server that delivers a query input by a client to the central native language Internet address database server and receives a corresponding URI or URL address, wherein: the central native language Internet address database server receives and registers native language Internet address data classified by languages, identifies a type of a language of the query input by the client, and delivers a corresponding URI or URL address to the native language Internet address server.

According to a sixth aspect of the present invention, there is provided a native language Internet address service method, comprising: registering native language Internet address data to build a native language Internet address database; when a query is input by a client, determining if the query is written in a native language serviced in a region or a language of another region; and when the input query is written in the native language, fetching a URI or URL address corresponding to the native language from the native language Internet address database server and, when the input query is written in the language of another region, fetching a URI or URL address corresponding to the query in cooperation with a native language Internet address service system in another region.

According to a seventh aspect of the present invention, a native language Internet address system includes: a native language Internet address database server for receiving and storing native language Internet address data written in languages of relevant region; a native language Internet address registration module connected to the native language Internet address database server for registering the native language Internet address data; and a native language Internet address server connected to the native language Internet address database server for delivering an query input by a client to the native language Internet address database server and receiving a corresponding URI or URL address from the native language Internet address database server, wherein: the native language Internet address system communicates with native language Internet address systems composed of languages of other regions in co-operation with the native language Internet address systems in response to a client's request.

According to an eighth aspect of the present invention, a native language Internet address system connecting to a central native language Internet address database server for receiving and storing native language Internet address data classified by regions, includes: a native language Internet address registration module connected to the central native language Internet address database server for registering the native language Internet address data; and a native language Internet address server connected to the central native language Internet address database server for delivering an query input by a client to the central native language Internet address database server and receiving a corresponding URI or URL address from the central native language Internet address database server, wherein: the central native language Internet address database server refers to region information added to the input query and delivers a URI or URL address corresponding to the query in cooperation with a native language Internet system in the region.

According to a ninth aspect of the present invention, a native language Internet address system connecting to a central native language Internet address database server comprising native language Internet address database servers of respective regions classified by regions, includes: a native language Internet address registration module connected to the central native language Internet address database server for registering the native language Internet address data; and a native language Internet address server connected to the central native language Internet address database server for delivering an query input by a client to the central native language Internet address database server and receiving a corresponding URI or URL address from the central native language Internet address database server, wherein: the central native language Internet address database server refers to region information added to the input query and retrieves a URI or URL address corresponding to the query in co-operation with a native language Internet system in the region.

According to a tenth aspect of the present invention, a native language Internet address system connected to a central native language Internet address database server comprising native language Internet address database of respective regions classified by regions, the system comprising: a native language Internet address database data having language information of its own region; a native language Internet address registration module for registering native language Internet address; and a native language Internet address server connected to the central native language Internet address database server, delivers the query to the native language Internet address database of its own region when the query input by a client is a query of the region, delivers the query to the native language Internet address central database when the query is not a query of the region, and fetches a corresponding URI or URL address.

According to an eleventh aspect of the present invention, a central native language Internet address database server for use in a native language Internet address system, includes: a native language Internet address registration module for registering region-specific native language Internet address data; and a native language Internet address server that delivers a query input by a client to the central native language Internet address database server and receives a corresponding URI or URL address, wherein: the central native language Internet address database server retrieves a URI or URL address corresponding to region information added to the input query and delivers the address to the native language Internet address server.

According to a twelfth aspect of the present invention, a native language Internet address service method includes: registering native language Internet address data of one region to build a native language Internet address database; when a query is input by a client, determining if the query is a request for service of the region or a request for service of another region; and when the input query is the request for service of the region, fetching a URI or URL address corresponding to the native language from the native language Internet address database and, when the input query is the request for service of another region, fetching a URI or URL address corresponding to the query in cooperation with a native language Internet address service system in another region.

According to a thirteenth aspect of the present invention, a native language Internet address cooperation system comprising a plurality of native language Internet address systems, each comprising a native language Internet address database server for receiving and storing native language Internet address data classified by region information and language information; and a native language Internet address server connected to the native language Internet address database server for identifying a language representing a query input by a client,

wherein when the query input to a specific native language Internet address server is written in a language of its own region, the cooperation system fetches a URI or URL address corresponding to the query from the native language Internet address database server and, when the query is written in a language of another region, fetches a corresponding URI or URL address in cooperation with a native language Internet address system of another region.

According to a fourteenth aspect of the present invention, a native language Internet address cooperation system comprising a plurality of native language Internet address systems, each native language Internet address system comprising a native language Internet address database server for receiving and storing native language Internet address data that is language information of its own region; and a native language Internet address server connected to the native language Internet address database server for responding to a query input by a client, wherein when the query input to a specific native language Internet address server is written in a language of its own region, the cooperation system fetches a URI or URL address corresponding to the query from the native language Internet address database server and, when the query is written in a language of another region, fetches a corresponding URI or URL address in cooperation with a native language Internet address system of another region.

### BRIEF DESCRIPTION OF THE DRAWINGS

FIG. 1 is a schematic block diagram of a native language Internet address system according to an exemplary embodiment of the present invention;

FIG. 2 is a detailed block diagram of a portion of the native language Internet system of FIG. 1;

FIG. 3 is a schematic block diagram illustrating cooperation between native language Internet systems according to an exemplary embodiment of the present invention;

FIGS. 4 and 5 show screens for adding and selecting a language-tag that is language and region information in a browser;

FIG. 6 is a schematic block diagram of a native language Internet address system according to a second exemplary embodiment of the present invention;

FIG. 7 is a schematic block diagram illustrating cooperation between native language Internet service systems according to the present invention;

FIG. 8 is a block diagram of a native language Internet address system according to a fourth exemplary embodiment of the present invention;

FIG. 9 is a schematic block diagram illustrating cooperation between native language Internet service systems shown in FIG. 8;

FIG. 10 is a block diagram of a native language Internet address system according to a fifth exemplary embodiment of the present invention;

FIG. 11 is a flowchart of a native language Internet address service method according to an exemplary embodiment of the present invention;

FIG. 12 is a schematic block diagram of a native language Internet address system according to a sixth exemplary embodiment of the present invention;

FIG. 13 is a schematic block diagram illustrating cooperation between native language Internet systems according to the sixth exemplary embodiment of the present invention;

FIG. 14 illustrates another example of a cooperation processing system of FIG. 13;

FIG. 15 is a schematic block diagram of a native language Internet address system according to an eighth exemplary embodiment of the present invention;

FIG. 16 is a schematic block diagram illustrating cooperation between native language Internet address systems according to a ninth exemplary embodiment of the present invention;

FIG. 17 is a schematic block diagram illustrating cooperation between native language Internet address systems according to a tenth exemplary embodiment of the present invention;

FIG. 18 illustrates a distributed central database according to the present invention;

FIG. 19 illustrates a registering transaction server according to exemplary embodiments of the present invention;

FIG. 20 illustrates a configuration of a transaction server and a central database server according to exemplary embodiments of the present invention;

FIG. 21 illustrates a temporary storage according to exemplary embodiments of the present invention;

FIG. 22 illustrates a client module scheme and a server-based scheme according to exemplary embodiments of the present invention; and

FIG. 23 is a flowchart illustrating a native language Internet address service method according to an exemplary embodiment of the present invention.

### BEST MODE FOR CARRYING OUT THE INVENTION

The present invention will now be described more fully with reference to the accompanying drawings, in which exemplary embodiments of the invention are shown. This invention may, however, be embodied in different forms and should not be construed as being limited to the exemplary embodiments set forth herein. Rather, these exemplary embodiments are provided so that this disclosure will be thorough and complete, and will fully convey the concept of the invention to those skilled in the art.

Some terminologies used herein are defined. A hierarchical English URL written in Letter, digit, Hyphen (LDH) that has been conventionally used as a domain name is called a “(English) domain name.” English or other languages in a keyword form that does not mean an existing English URL are referred to as “native language.” “Query” indicates a string of letters that a user enters to access a specific web page and may correspond to either an “(English) domain name” or “native language.”

A native language Internet address system is not a system intended to substitute for a DNS but is a new naming system based on a keyword written in a native language. Accordingly, a native language Internet address system according to the present invention uses a keyword written in a native language to access various resources such as web, mail, telephone, and fax.

This system may accommodate data of a variety of languages and regions (e.g., countries), and processing servers communicate data in the same standpoint, not branches from a root in a hierarchical domain. The system is also able to process all letters in the world that can be written in Unicode, by using a letter language in a UCS transformation format (UTF).

Native Language Internet Address System Having Language-Specific Databases.

### First Exemplary Embodiment

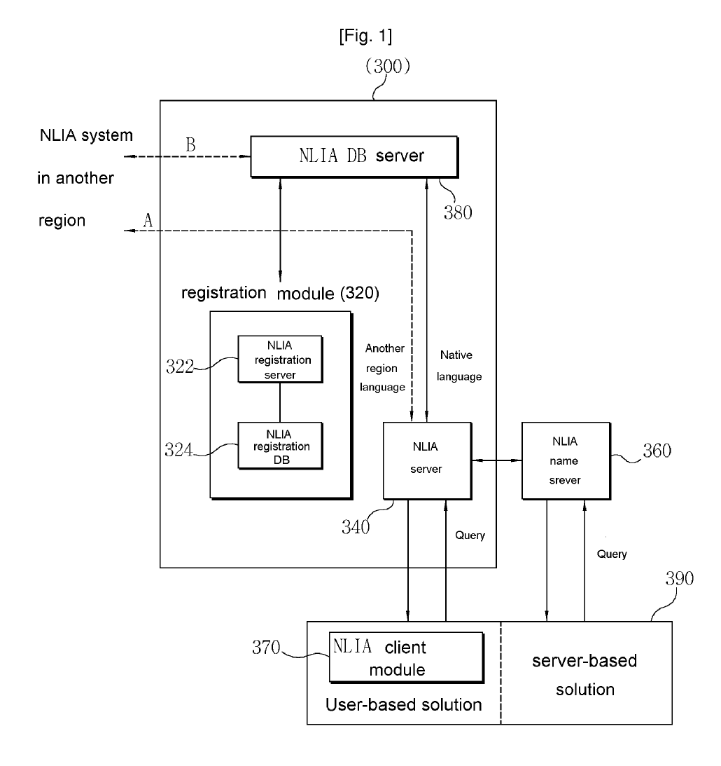

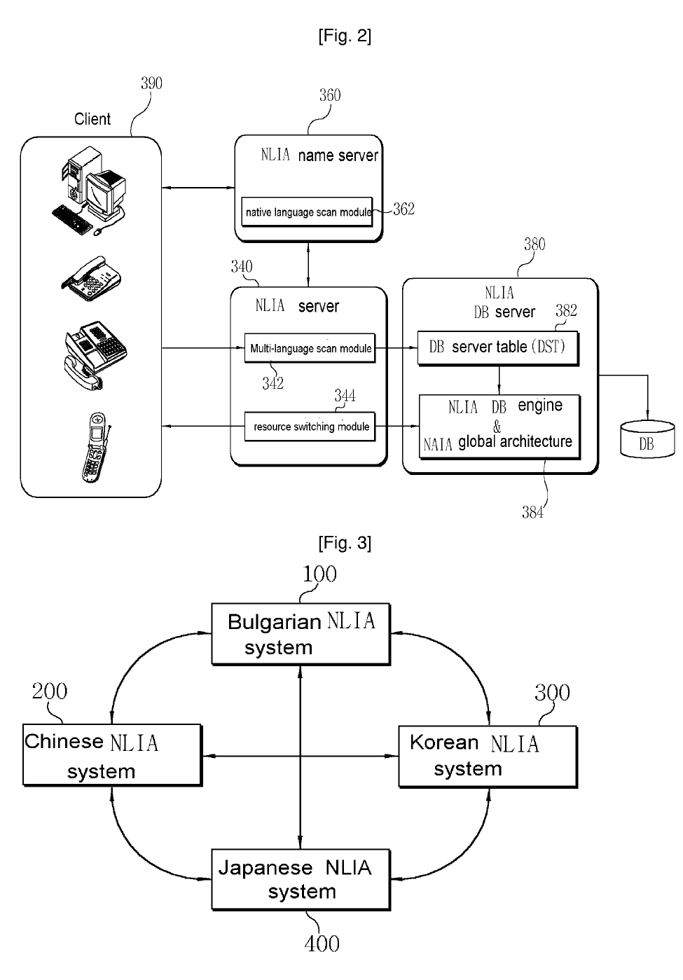

FIG. 1 is a schematic block diagram of a native language Internet address system according to an exemplary embodiment of the present invention, FIG. 2 is a detailed block diagram of a portion of the native language Internet system of FIG. 1, and FIG. 3 is a schematic block diagram illustrating cooperation between native language Internet systems according to an exemplary embodiment of the present invention.

Referring to FIG. 1, a native language Internet address (NLIA) system 300 comprises a registration module 320 for registering a native language Internet address, an NLIA database server 380 for collecting the registered native language from the registration module 320, and an NLIA server 340 for identifying a language representing a query input by a client 390 and resolving the identified language.

When the input query is written in a native language, the NLIA server 340 fetches a corresponding URI or URL address from the NLIA database server 380 if the native language is used in a corresponding region, and fetches a corresponding URI or URL address from an NLIA service system of another region (e.g., 100, 200 and 400 of FIG. 3) if the native language is used in the other region (See path A of FIG. 1).

The word “region” means country but is not limited thereto. There may be several regions in one country and several countries may belong to one region. Further, there may be two or more language-specific databases in one region. For example, when Canada is selected as a region, Canada has two language-specific databases since English and French are both used in Canada.

In a system classified by languages, when two or more languages are retrieved, they are preferably listed so that one of them can be selected.

When name, language, region, and data type of a user-desired resource are delivered to the NLIA server 340, an accessible address to the desired resource is fetched. The NLIA server 340 enquires about a relevant NLIA database or native language email address (NLEA) database according to characteristics of the data, and receives a URI or URL address enabling access to the information. While in FIG. 1 reference number 380 indicates the NLIA database server, a further NLEA database server may be provided and will be described later.

The registration module 320 serves to register native language Internet addresses. For example, the registration module 320 may be configured like an existing domain registration system composed of web pages. The registration module 320 handles native language Internet addresses and thus all data are stored in the form of UTF-8 or UCS (Universal Letter Set). To register a native language Internet address in the registration module 320, general users may directly register the native language Internet address through their client, an NLIA system provider may register the native language Internet address, or a combination thereof may be allowed.

When an input query is written in a language of another region, the NLIA server 340 fetches a URI or URL address corresponding to the language from an NLIA system of the region (e.g., 100, 200 and 400 of FIG. 3). For example, the NLIA database server 380 functions to retrieve requested data and may be configured to process data that cannot be processed by the NLIA database server 380, in cooperation with NLIA database servers of NLIA systems (e.g., 100, 200 and 400 of FIG. 3) in other regions (See path B). The data fetched from the external NLIA database server may be cached for a certain time to enhance performance. Preferably, unnecessary traffic is suppressed.

The NLIA database server 380 cooperates with the NLIA systems classified by regions and languages. The data registered through the registration module 320 is delivered to the NLIA database server 380. Preferably, a transaction module (not shown) may be additionally provided between the registration module 320 and the NLIA database server 380. Data registered by the NLIA registration module 220 is delivered to the transaction module. An NLIA transaction module (not shown) has information on the serving NLIA database server 380 for real-time application. The NLIA transaction module also functions to synchronize data that is not delivered, by sharing time information of the data with the NLIA database server 380 upon data delivery.

The NLIA system 300 may comprise an NLIA name server 360, if necessary. The NLIA name server 360 has a function of processing a native language Internet address, in addition to the DNS function. The NLIA name server 360 determines if a connection word input by the client 390 is an English language domain name or a native language domain name. If the connection word is the English language domain name, the NLIA name server 360 connects to a typical DNS server (not shown) and fetches a corresponding URL or IP address. If the connection word is written in the native language, the NLIA name server 360 delivers the connection word to the NLIA server 340.

FIG. 2 is a detailed block diagram of a portion of the native language Internet system of FIG. 1. The NLIA name server 360 comprises a native language scan module 362, the NLIA server 340 comprises a multi-language scan module 342 and a resource switching module 364, and the NLIA database server 380 comprises a database server table 382 and an NLIA database engine & global architecture module 384. The modules 362, 342, 344, 382, and 384 are extendable to allow a native language Internet address to be available to various clients which have a variety of devices and programs. Accordingly, the native language Internet address system according to the present invention is available in several programs and platforms, as well as HTTP.

The native language scan module 362 in the NLIA name server 360 separately processes a typical domain name and a native language Internet address. The multi-language scan module 342 in the NLIA server 340 collects various information from the user, extracts information that can be processed, and recognizes features of a requester. The resource switching module 344 converts into data received from the native language Internet address database server 380 into a format that can be processed by the client 390 prior to actually sending the received data to the client 390. The multi-language scan module 342 recognizes characteristics of data to be retrieved from the database-based on information that can be extracted through this module with data delivered from Users accessed through the NLIA name server 360 or protocol used in the system.

The database server table 382 included in the NLIA database server 380 determines an NLIA system to retrieve based on the information extracted by the multi-language scan module 342. The NLIA global architecture module 384 retrieves native language internet addresses in other regions and caches them in cooperation with NLIA systems throughout the world. The NLIA global architecture module 384 also uses literal characteristics to extract data closest to the user and apply it.

The multi-language scan module 342 of the NLIA server 340 identifies an address system as a form desired by users through various kind of information, such as operating systems, application programs, language codes, letter codes, and IP addresses, from users. NLIA database server 360 recognizes a corresponding address system at the basis of the delivered data. The obtained address system in that way above is converted and provided in a format accommodated by the client 390 by the resource switching module 344.

Preferably, the client 390 is a computer. Alternatively, the client 390 may be another communication device that can connect to the Internet, such as a mobile terminal, telephone, fax, or the like.

Actual implementation, including cooperation between native language Internet systems, according to an exemplary embodiment of the present invention will now be described in detail by way of example with reference to FIGS. 1 to 3. FIG. 3 is a schematic block diagram illustrating cooperation between native language Internet systems according to an exemplary embodiment of the present invention. In FIG. 3, a Bulgarian NLIA system 100, a Chinese NLIA system 200, and a Japanese NLIA system 400 that are the same as the Korean NLIA system 300 are connected to each other.

(1) Discrimination of Languages and Regions

In the first exemplary embodiment, the native language internet address system, NLIAS, uses language and region information (e.g., country information) to divide systems. This is because two or more languages may be used together in one region (country) and one language may be used in several regions.

The NLIA system NLIAS according to the first exemplary embodiment may use RFC 1766 (Tags for the Identification of languages). For example, it divides and operates the systems according to the reference of RFC 1766 using a combination of languages and country codes written in ISO 639 (code for representing names of languages) and ISO 3166 (code for representing names of countries).

A system that is separately operated based on the “language-tags RFC 1766” is regarded as one registry, and if several languages are used in one region, there may be a plurality of registry systems.

(2) Cooperation Between Registry Systems that are Separately Operated According to Regions and Languages

The separately operated registry systems deliver data from the NLIA server 340 to the NLIA database server 380 in response to a user's query. The thus delivered data includes “language-tag” information. Upon receipt of a request data for “language-tags” that is not related to the NLIA database server 380, the NLIA database server 380 delivers the request data to a system capable of processing the request data over a native language Internet address (NLIA) communication channel, receives the result from the system, and sends the result to the NLIA server 340.

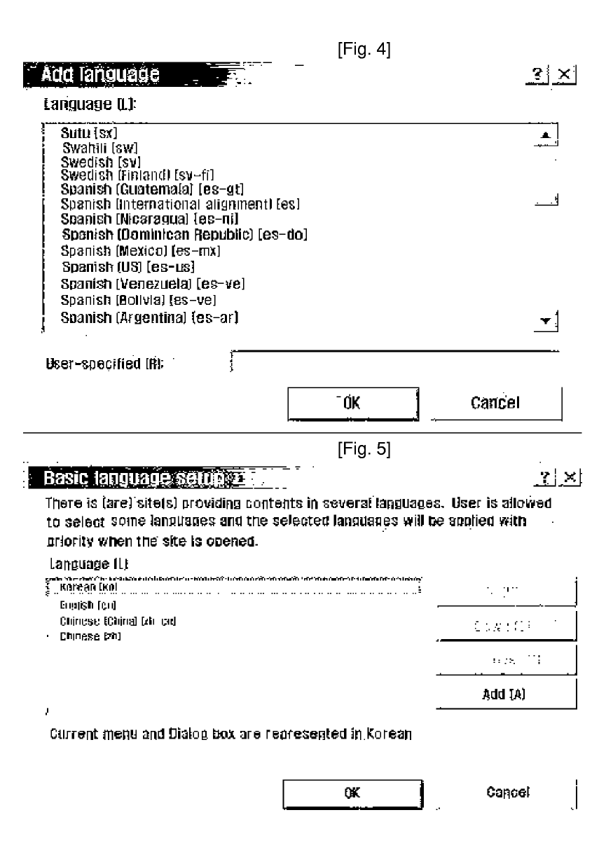

For example, when a Korean language-tag user in China requests an NLIA server of the Chinese NLIA system 200 to provide a Korean language keyword, the Chinese NLIA system 300 requests a Korean NLIA system 300 supporting Korean language service to provide data corresponding to a requested keyword over the NLIA communication channel. The external data as provided is automatically cached in the NLIA database server and stored during time-to-live (TTL) indicated by the data, such that it is possible to provide native language keyword service no matter what language a request for the keyword service is made by using external data without deteriorating system performance. FIGS. 4A and 4B show screens for adding and selecting a language-tag which is language and region information in a browser.

The cooperation service may be implemented according to other schemes. That is, when a user inputs a Chinese keyword to a France NLIA system, the France NLIA system identifies countries that use Chinese characters by a code value of the Chinese characters, and requests a corresponding NLIA system to provide data over the NLIA communication channel. When a Chinese character is input to the France NLIA system, the France NLIA system requests data to provide the Chinese NLIA system and the Japanese NLIA system which use Chinese characters by means of a code value of the Chinese characters and receives corresponding data for service.

(3) Intelligent Retrieval for Native Language Internet Address

In the native language Internet address system, native language Internet addresses are internally written in UTF-8. UTF (UCS transformation format) is Unicode and has one-to-one correspondence as implied by its name, and countries using letters written in Unicode are identified by a letter code value. For example, a language using the syllable [symbol] (U+0xAC00) is the Korean language and a language using the letter [symbol] (U+0x3041) is the Japanese language.

With this letter characteristic, the NLIA server 340 pre-stores a range of letters that are processed by the NLIA database servers 380 configured by “language-tags”, and when there is a request from a user, retrieves the range of letters input by the user, determines a list of NLIA database servers capable of performing processing, and retrieves a system belonging to the list, so that service is available even when the user does not set or erroneously sets “language-tags.”

Further, the native language Internet addresses may be utilized as various Internet addresses and have an extendable structure (may be processed into a native language email address). Accordingly, the native language Internet address system is designed to be used to access various Internet addresses (naming space). It is possible to provide Internet-based service such as FTP and TELNET, as well as World Wide Web (WWW), and information such as telephone, fax, and personal information.

Further, in the native language Internet address system, a conventional English language domain written after the symbol “@” in “native language ID @ native language Internet address” (which uses a Mail eXchange (MX) resource record (RR) value of a DNS) is written in a native language Internet address. The left side as well as the right side may be written in a native language. This service enables an existing English language address to be more easily recognized and retrieved.

The native language Internet address system is able to process a native language Internet address and a native language email address by using the NLIA server. The native language Internet address system may use the native language email address database server. Alternatively, the native language Internet address system may use a lightweight directory access protocol (LDAP) for email. In addition, the native language Internet address system is able to process native language email addresses having the format “@native language Internet address.” This is accomplished by using another native language Internet address server.

(4) Data Synchronization Method

A server for processing a native language Internet address does not include just a single server but is designed to have a distributable structure and to support a regional distribution. For example, a server having “ko” as a “language-tag” may be placed in other countries as well as in Korea. If systems are distributed, a newly registered native language Internet address should be applied to all of the systems in a short time. Preferably, the native language Internet address (NLIA) transaction server registers addresses in real time.

This system has a function of sending the newly registered native language Internet address to the serving NLIA database server 380. The NLIA database server 380 has an additional function of applying data, in real time, which is received from the native language Internet address transaction server. The added data is converted to be binary-searched for in a memory to provide service.

Further, the serving NLIA database server 380 functions to deliver its own data information to the native language Internet address transaction server so that the data is always synchronized in preparation for midway loss whenever the serving NLIA database server 380 restarts or receives new data. In the data synchronizing method, a last data time indicating when data was last received by the system is communicated upon data transmission or reception. When there is an error in the last data time, last data is communicated so that information is always kept recent.

(5) Communication Method for Client (Browser, Native Language Internet Address Client Module, Mail User Agent) and Native Language Internet Address Server (NLIA Resolution Server)

The client 390 and the NLIA server 340 communicate using hypertext transfer protocol (HTTP). An application for a client (web browser, mail user agent, or Internet application program) as well as protocol for a web browser performs socket communication using HTTP.

The well-known HTTP is used because numerous systems are based on HTTP communication, guaranteeing stability and security.

(6) Communication Method for Native Language Internet Address (NLIA) Server and Native Language Internet Address Database Server

All data are written in UTF-8 letters. The data contains a length of the letter, allowing various letters and languages to be processed. A basic form is made by referring to a “Chunked Transfer Coding” method in RFC 2616 (Hypertext Transfer protocol-HTTP/1.1) of “length/r/n data/r/n.” There is a difference in that a decimal chunk-size is used instead of a hexadecimal chunk-size.

TABLE 1

Chunked-Body = *chunk last-chunk*chunk = chunk-size
[ chunk-extension ] CRLF chunk-data CRLFchunk-size =
1*Decimal (0-9)last-chunk = 1* 0 [ chunk-extension ]
CRLF
data sequence: language-tags, type, dataExample:
2\r\ko\r\n4\r\nhttp\r\n14\r\nwww.netpia.com\r\n0\r\n

The native language Internet address server 340 enquires data with a “language-tags” value requested by a user and, when there is a result, delivers the “language-tags” as an “auto” value so that native language Internet address intelligent search is possible.

(7) Communication Method for Native Language Internet Address (NLIA) Database Server

Native language Internet address systems classified by “language-tags” perform data communication according to the communication method for a native language Internet address server and a native language Internet address database server, wherein information is distinguished and processed by using “language-tag” information.

The native language Internet address database server performs a process over a native language Internet address (NLIA) communication channel. An information table of this channel is processed using a list of native language Internet address database servers, which is called a database server table (DST). The table conserves recent information, which is updated in real time by the native language Internet address database servers.

### Second Exemplary Embodiment

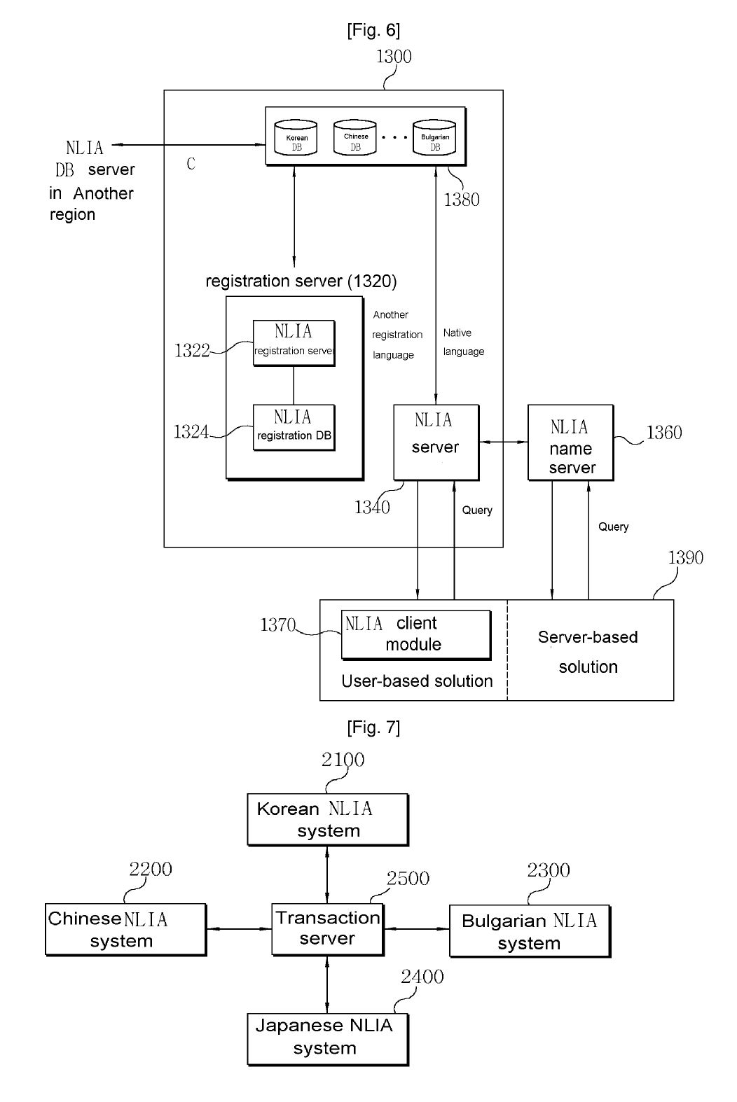

A native language Internet address system 1300 according to a second exemplary embodiment of the present invention will be described in detail with reference to the accompanying drawings. For convenience of illustration, differences between the first exemplary embodiment and the second exemplary embodiment will be mainly described, and description of overlapping content will be omitted. FIG. 6 is a schematic block diagram of a native language Internet address system 1300 according to a second exemplary embodiment of the present invention.

The native language Internet address system 1300 comprises a native language Internet address database server 1380 for storing native language Internet address data classified by languages; a native language Internet address registration module 1320 connected to the native language Internet address database server 1380 for registering the native language Internet address data; and an NLIA server 1340 connected to the NLIA database server 1380 for identifying a language representing a query input by a client 1390.

The NLIA server 1340 identifies a type of language representing the input query, and fetches a corresponding URI or URL address from the native language Internet address database server corresponding to the language. The native language Internet address database server 1380 is updated in cooperation with an NLIA database server of a native language Internet address system of each country.

In the first exemplary embodiment, when an input query is written in a native language, the NLIA server (340 of FIG. 1) fetches a URI or URL address corresponding to the native language from the NLIA database server (380 of FIG. 1), and when the query is written in a language of another region, fetches a URI or URL address corresponding to the language from an NLIA system of the region. Whereas in the second exemplary embodiment, the NLIA database server 1380 is updated in co-operation with the NLIA database server of the native language Internet address system of each country, such that a query input by the client 1390 is processed at the NLIA database server 1380 whether the query is written in a native language or another country's language (See path C of FIG. 6). Cooperation among the language-specific databases is performed in real time or another specified time.

### Third Exemplary Embodiment

A native language Internet address system according to a third exemplary embodiment of the present invention will be now described in detail with reference to FIG. 6, which is a schematic block diagram illustrating cooperation between native language Internet service systems according to the present invention.

FIG. 7 shows another implementation of a cooperation processing system of FIG. 3. In FIG. 3, the Bulgarian NLIA system 100, the Chinese NLIA system 200, and the Japanese NLIA system 400, each being the same as Korean NLIA system 300, are connected to one another. Whereas in FIG. 7 they are connected to one another via the transaction server 500. This transaction server-based scheme may be applied to both the first and second exemplary embodiments described above. Using the transaction server 500, the language-specific databases may be discovered for retrieval (the first exemplary embodiment) or they may be made to cooperate with one another for synchronization (the second exemplary embodiment).

### Fourth Exemplary Embodiment

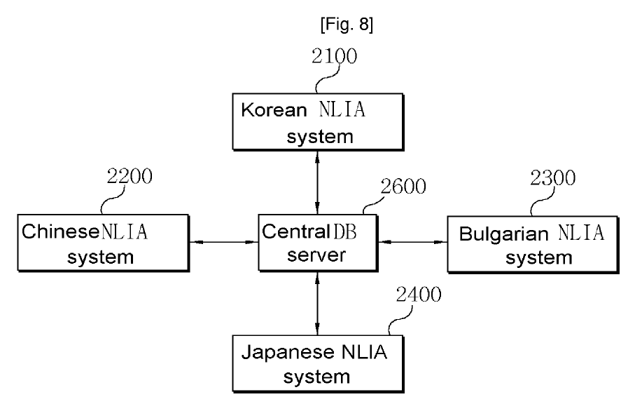

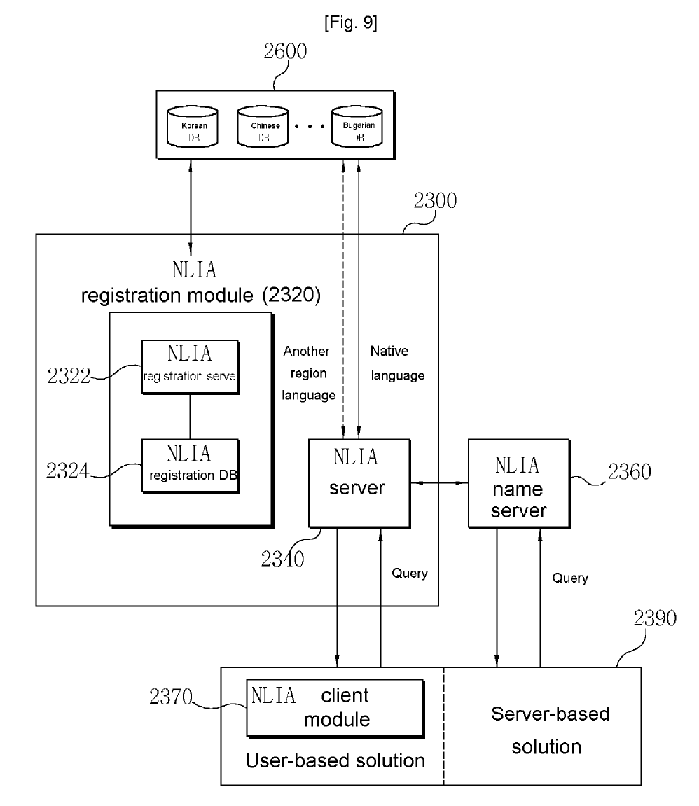

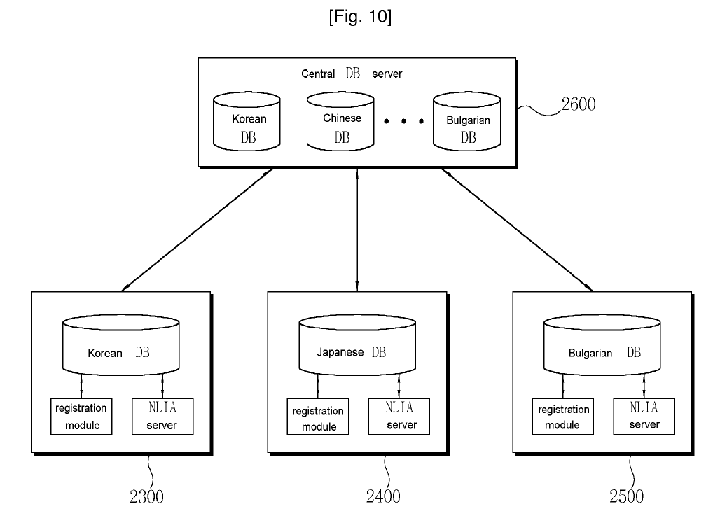

A native language Internet address system according to a fourth exemplary embodiment of the present invention will be described in detail with reference to FIGS. 8 and 9. FIG. 8 is a block diagram of a native language Internet address system according to a fourth exemplary embodiment of the present invention, and FIG. 9 is a schematic block diagram illustrating cooperation between native language Internet service systems shown in FIG. 8. Referring to FIG. 8, the native language Internet address systems cooperate with a central database server 2600.

The central database server 2600 stores native language Internet address data classified by languages, identifies a type of a language representing a query input by the client 2390, and delivers a URI or URL address corresponding to the language to the NLIA server 2340.

The NLIA database server 1380 of the second exemplary embodiment is updated in cooperation with the NLIA database server of the native language Internet address system of each country while the central database server 2600 of the fourth exemplary embodiment identifies a type of a language representing the query input by the client 2390, retrieves a URI or URL address corresponding to the language from internal language-specific databases, and delivers the retrieval result to the native language Internet address server 2340. The native language Internet service systems connected to the central database server 2600 provide this result to the client 2390 as a response.

The central database server 2600 provides a different speed for each country, solving a problem of a non-uniform processing speed upon receipt of a response to a query from the native language Internet address systems built in the countries. This facilitates a stabilized system.

### Fifth Exemplary Embodiment

A native language Internet address system according to a fifth exemplary embodiment of the present invention will now be described in detail with reference to FIG. 9, which is a block diagram of a native language Internet address system according to the fifth exemplary embodiment of the present invention.

The central database server 2600 receives and stores native language Internet address data classified by language, and native language Internet systems have a copy of an NLIA database in its own region.

The fifth exemplary embodiment differs from the fourth exemplary embodiment in that the native language Internet service systems according to the fifth exemplary embodiment have language-specific databases. With this configuration, each native language Internet system identifies a type of a language representing queries and delivers only queries that are not retrieved from a native language Internet address database of its own region to a central database server 2600. Accordingly, each NLIA system has only to communicate with a central server and no other servers. Thus it can improve processing speed and simplify management.

Language-Specific Database-Based Native Language Internet Address Service Method

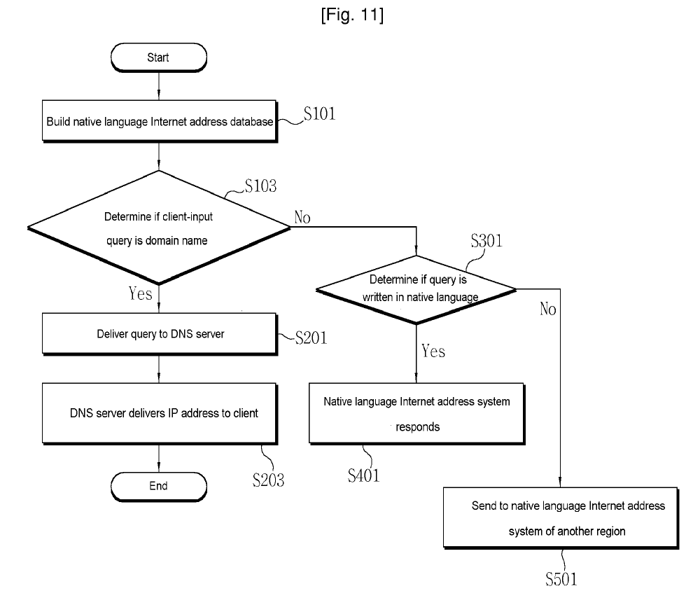

A native language Internet address service method according to an exemplary embodiment of the present invention will be now described with reference to FIG. 11, which is a flowchart of a native language Internet address service method according to an exemplary embodiment of the present invention.

First, native language Internet address data are registered to build a native language Internet address database (S101).

Next, when a query is input from a client, it is determined if the query is an English language domain or not (S103). Here, the query may include language and region information. Specifically, the language and region information may be selected by a language tag that is selected in a browser (Refer to the description related to FIGS. 4A and 4B). If the query is the English language domain, the query is delivered to the DNS server (S201). In response to receiving the query, the DNS server delivers an IP address to the client (S203). If the query is not the English language domain, the query is delivered to the native language Internet address system. This function may be performed by the NLIA name server 360 or the NLIA client module 370 of FIG. 1.

If the query does not indicate a typical domain, the native language Internet address system determines if the query is written in a native language or a language of another region (S301). In the native language Internet address system for Korea, Korean language is stored in the native language Internet address database server. Accordingly, if the query is a Korean language query, it is determined to be the native language and the query is sent to the Korean native language Internet address system. The Korean native language Internet address system responds to the enquiry (S401). If the query is Japanese, Chinese, or the like, not the Korean language, the query is sent to a native language Internet address system of another region (S501). In the case of English, which is used in many regions, the query may be regarded as the native language.

It is problematic to address a query when a language is used in several regions. For example, Spanish is used in several regions. When there are several retrieval results, direct connection is not performed and the retrieval results are enumerated so that one can be selected. It is convenient to use a language-tag shown in FIGS. 4A and 4B. Of course, the region may be selected through an identifier in advance by embedding the identifier indicating a regional division together with the query if necessary.

Meanwhile, it is problematic to address a query that is not registered in native language Internet address systems in other regions. i) This non-registered query may be delivered to an NLIA database server in a pre-specified region (i.e., native language Internet address system), ii) a retrieval result may be obtained and sent in association with a retrieval site, or iii) a similar value may be retrieved from all NLIA database servers in respective regions.

Region-Specific Database-Based Native Language Internet Address System

### Sixth Exemplary Embodiment

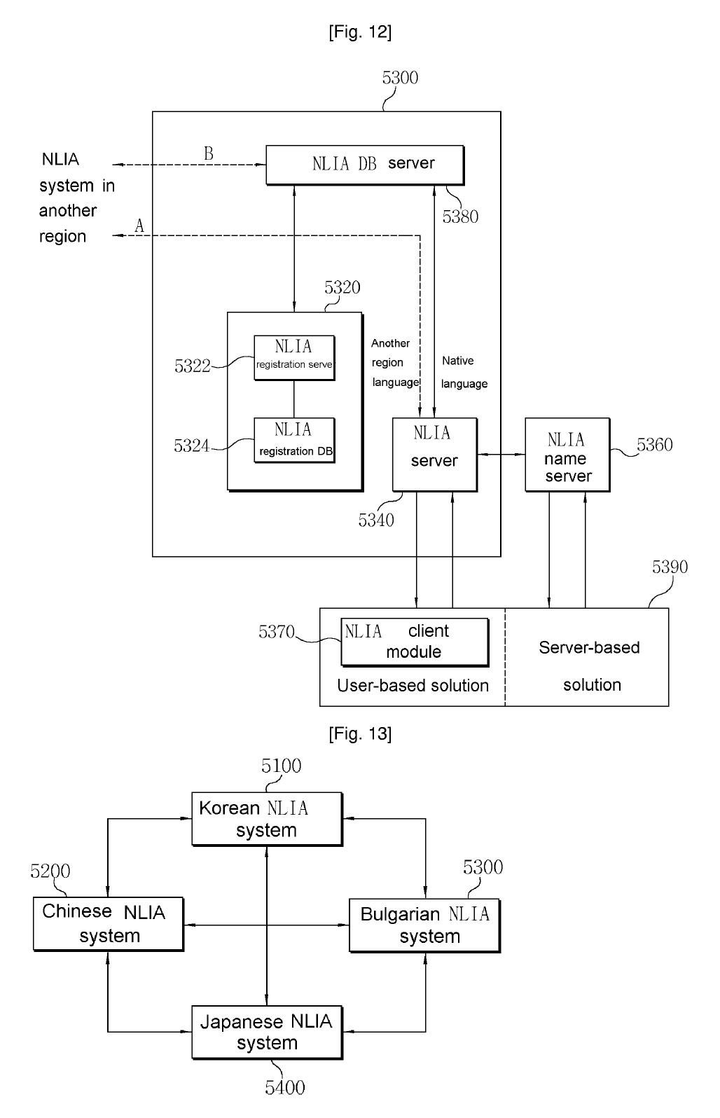

FIG. 12 is a schematic block diagram of a native language Internet address system according to a sixth exemplary embodiment of the present invention, and FIG. 13 is a schematic block diagram illustrating cooperation between native language Internet systems according to the sixth exemplary embodiment of the present invention.

Referring to FIG. 12, a native language Internet address service system 5300 comprises a registration module 5320 for registering native language Internet address data written in languages of a relevant regions, an NLIA database server 5380 for collecting the registered native languages from the registration module 5320, and an NLIA server 5340 for resolving a query input by a client 5375.

Unlike language-specific database-based native language Internet address systems of the first to fifth exemplary embodiments described above, a native language Internet system of the sixth exemplary embodiment comprises region-specific databases for a plurality of languages. That is, Korean language Internet address data may be registered in other regional systems as well as a Korean region native language Internet address system. Native language Internet address systems in respective regions register all languages without discrimination.

Accordingly, a native language Internet address system in one region cooperates with native language Internet address systems for languages in other regions and, upon receipt of a request from a client, communicates with the native language Internet address systems in other regions. Communication with native language Internet address systems in other regions is accomplished via the NLIA server 5340 (path A of FIG. 11) or the NLIA database server 5380 (path B of FIG. 11).

The region-specific native language Internet address systems are classified by service regions irrespective of language. This is because two or more languages may be used in one country or one language may be used in several countries. A system classified and operated by regions is regarded as one registry. There may be one registry system in one region, but a region does not always correspond to a country.

Cooperation among respective registry systems that are classified and operated by region will be discussed.

In response to a user's query, the registry systems deliver data from the NLIA server 5340 to the NLIA database server 5380. For example, when a specific region is selected by specifying identifier, code, and the like in the user query, the registry system delivers data to a system and database that can process it through a native language Internet address (NLIA) communication channel, receives the result, and delivers the result to the NLIA server 5340 for processing.

When a native language enquiry in a typical form is made without selecting a specific region, a result is found from a database server of the regional registry to respond. When an enquiry is made with selection of a specific region such as Korea or China, a Korean NLIA system requests the China NLIA system that is the specified region to provide the data corresponding to the requested keyword over the NLIA communication channel, and receives the result. The data from the NLIA system in the specific region is automatically cached in the native language Internet address database server and stored during time-to-live (TTL) indicated by the data. Accordingly, it is possible to provide native language keyword service without degrading system performance even when there is a request for service of other regions using external data.

The native language Internet addresses may be utilized as various internet addresses and have an extendable structure (may be processed into a native language email address). Accordingly, a native language Internet address system is designed to be utilized to access various Internet addresses (naming space). It is possible to provide Internet based service such as FTP and TELNET, as well as World wide web (WWW), and information such as telephone, fax, and personal information.

Further, in the native language Internet address system, a conventional English language domain appearing after “@” in a “native language ID @ native language Internet address” format (which uses a Mail eXchange (MX) resource record (RR) value of a DNS) is written in a native language Internet address. The left side as well as the right side may be written in a native language. This service enables existing English language addresses to be more easily recognized and retrieved.

The native language Internet address system is able to process a native language Internet address and a native language email address by using the NLIA server 3300. The native language Internet address system provides service through the native language email address database server, but the native language Internet address system may use a lightweight directory access protocol (LDAP) for email.

In data synchronization, last data time of the system is sent upon sending and receiving the data, and when the last data time has an error, the last data is communicated so that information is always kept recent.

Communication between the client (browser, native language Internet address client module or MUA) and the native language Internet address server (NLIA resolution server) will be discussed.

When a client inputs a query, the query is delivered to a name server according to a typical address processing procedure. The name server determines if the user-input query is a domain or not, and when it is not the domain, delivers the query to the regional NLIA system or provides an address of the NLIA system as a response to the user so that the query is sent to the NLIA system. Alternatively, a native language Internet address client module placed in the client determines a type of a query input through, for example, an address window, and when it is not a domain, delivers the query to the regional NLIA system.

If service of another region is desired, the region can be selected by inputting a predefined specific identifier and a letter indicating a region together. The regions may be selected by using a client program.

The client 5390 and the NLIA server 5340 communicate by using hypertext transfer protocol (HTTP). An application for a client (web browser, mail user agent, or Internet application program) as well as protocol for a web browser performs socket communication using HTTP. The well-known HTTP is used because a number of systems are based on HTTP communication, guaranteeing stability and security.

### Seventh Exemplary Embodiment

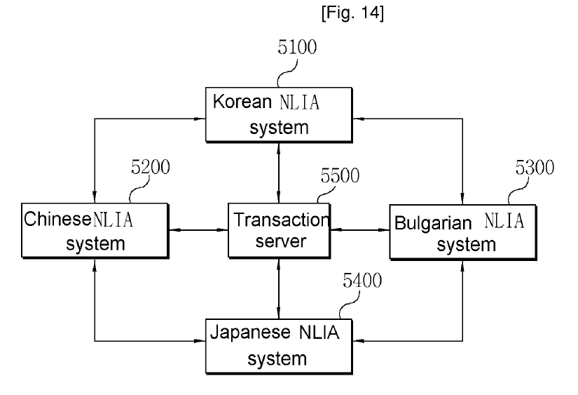

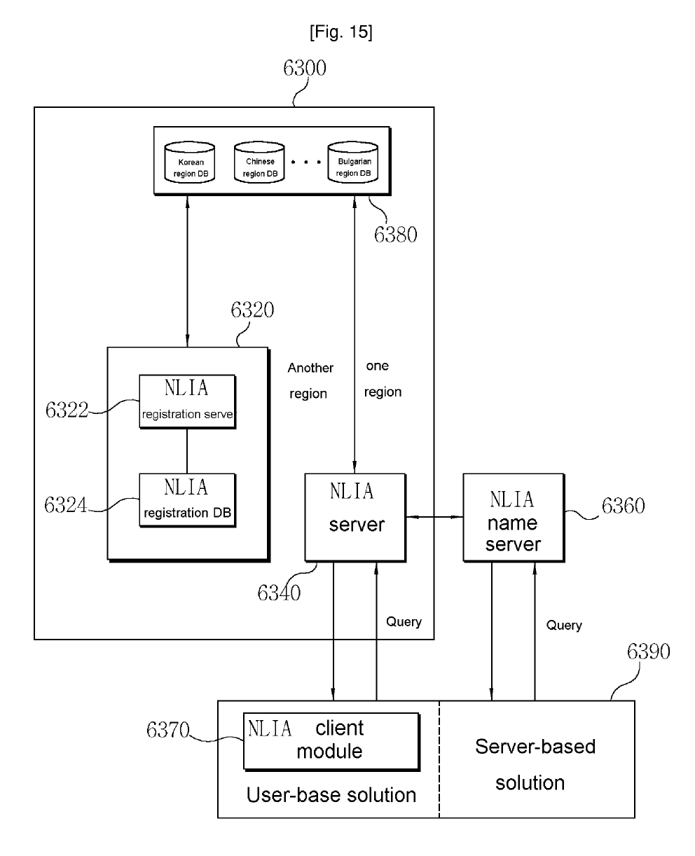

FIG. 14 shows another implementation of a cooperation processing system of FIG. 13. While in FIG. 13 the Korean NLIA system 5100, the Chinese NLIA system 5200, and the Japanese NLIA system 5400, which are the same as the Bulgarian NLIA system 5300, they are connected to one another, in FIG. 14, they are connected to one another via the transaction server 5500. The NLIA systems 5100, 5200, 5300, and 5400 communicate with the transaction server 500.

The plurality of regional NLIA systems may cooperate with one another to provide roaming service. The NLIA system retrieves a requested keyword from its database, and when it does not discover the keyword from the database, requests a designated database in another region system to retrieve the keyword, and receives corresponding data to provide the service.

When the NLIA system does not discover corresponding data from the database, the NLIA system provides a retrieval result from a cooperating search service provider or discovers and provides a similar value from the database of the NLIA system so that a user obtains a desired result more rapidly.

In the system including a plurality of region NLIA systems, such as the Korean NLIA system 5100, the Chinese NLIA system 5200, the Bulgarian NLIA system 5300, and the Japanese NLIA system 5400, when registration with the system of another region is desired, the registration may be performed in each regional system. Alternatively, the registration may be performed from a system in a relevant region to another region system. The registration system of the regional NLIA system enquires to a user-specified region system whether registration is possible, and provides the result, and sends a request for registration to the region system in response to a user's request.

### Eighth Exemplary Embodiment

A native language Internet address system 6300 according to the eighth exemplary embodiment of the present invention will be described in detail with reference to the accompanying drawings. For convenience of illustration, a difference with the sixth exemplary embodiment will be described. FIG. 14 is a schematic block diagram of a native language Internet address system 6300 according to an eighth exemplary embodiment of the present invention;

The native language Internet address system 6300 comprises an NLIA database server 6380 for receiving and storing native language Internet address data classified by regions, a registration module 6320 connected to the NLIA database server 6380 for registering the said native language Internet address data, and an NLIA server 6340 connected to the NLIA database server 6380 which resolves a query input by a client 6390.

In the sixth exemplary embodiment, when an input query is originated from a region of the NLIA server, the NLIA server fetches a corresponding URI or URL address from the NLIA database server and when an input query originates from other region, the NLIA server fetches a corresponding URI or URL address from an NLIA service system in the other region, on the other hand, in the eighth exemplary embodiment, the NLIA database server 6380 is updated in cooperation with an NLIA database server of a native language Internet address system of each region, such that a query input by the client 6390 is processed by the NLIA database server 6380 regardless of the region from which the query is originated. Cooperation between region-specific databases is performed in real time or another specified time.

### Ninth Exemplary Embodiment

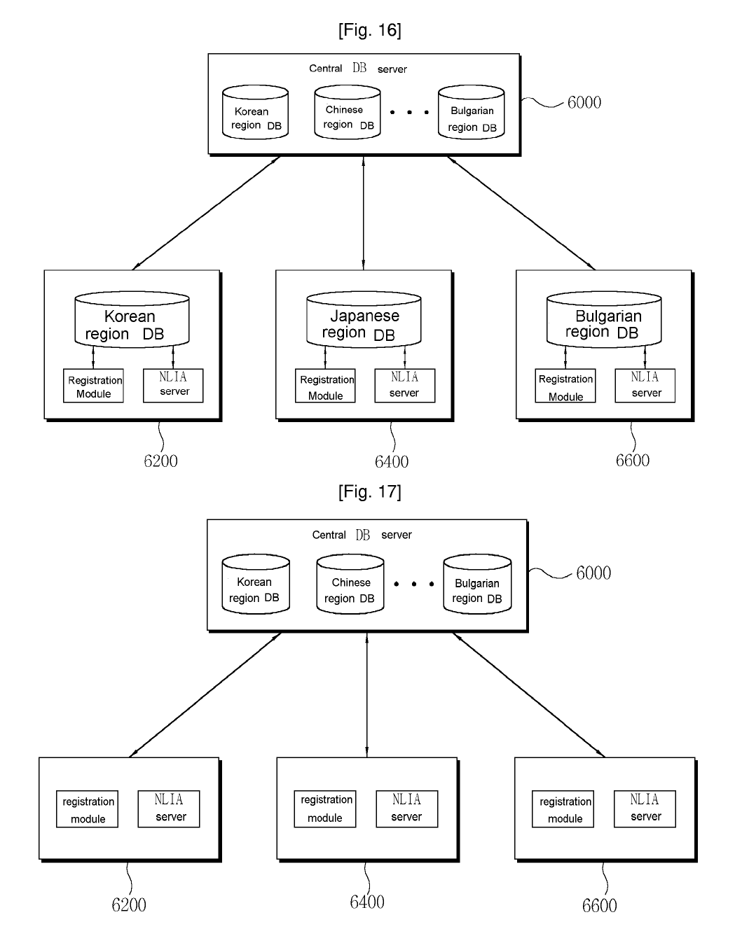

FIG. 16 is a schematic block diagram illustrating cooperation between native language Internet address systems according to a ninth exemplary embodiment of the present invention. Referring to FIG. 16, native language Internet address systems 6200, 6400 and 6600 cooperate with a central database server 6000.

The central database server 6000 receives and stores native language Internet address data classified by regions. When a client-input query needs service from other regions, the central database server 6000 retrieves a corresponding URI or URL address from the region service database and sends the address information to an NLIA system in a region from which the query is sent.

The central native language Internet address database server 6000 has the same copy as that each region NLIA system database has, and an NLIA system in each region has only to communicate with only the central server without necessary to communicate, thereby improving a processing speed and simplifying management. As a variation of the exemplary embodiment, the NLIA system database in each region may be dedicated only to the central database 6000 (See FIG. 16).

### Tenth Exemplary Embodiment

FIG. 17 is a schematic block diagram illustrating cooperation among native language Internet address systems according to a tenth exemplary embodiment of the present invention. Referring to FIG. 17, region-specific native language Internet address systems 6200, 6300, and 6400 cooperate with a central database server 2600.

The central database server 2600 receives and stores native language Internet address data classified by regions, and a URI or URL address corresponding to a language of a query input by a client to a native language Internet address server.

In the ninth exemplary embodiment, only the central database server 6000 has a region-specific database while the region-specific native language Internet address systems 6200, 6300 and 6400 does not have a region-specific database, unlike the eighth exemplary embodiment.

Components that may be added or changed in the first to tenth exemplary embodiments will be now discussed.

Distributed Central Database Server

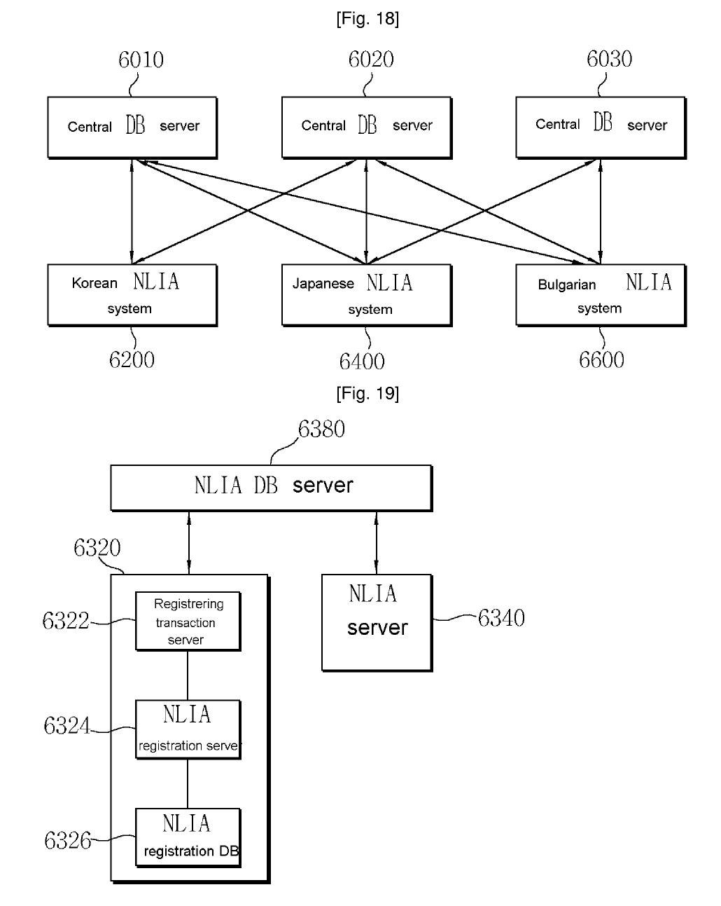

FIG. 18 illustrates a distributed central database according to exemplary embodiments of the present invention. The distributed central database server may be implemented by any system having a central database server and may be applied to the fourth, fifth, ninth and tenth exemplary embodiments.

Referring to FIG. 18, the native language Internet address systems 6200, 6400 and 6600 cooperate with a plurality of central database servers 6010, 6020 and 6030. The central database servers 6010, 6020 and 6030 are composed as two or more systems located in different regions so that one of the systems performs processing which can provide the fastest response when information is requested.

One of the distributed central database servers 6010, 6020 and 6030 may be a reference server to provide synchronization between the distributed central database servers. Other copy servers are updated with data at a specific time or in real time and are synchronized based on a value of the reference server. Further, in order to provide data synchronization, all data may be authenticated by the reference server. Accordingly, the registration system of each regional system delivers contents to the reference server upon adding and modifying data.

Further, the serving NLIA database server functions to send its information to the reference server to provide synchronization at all times in preparation for loss upon restart or data reception.

Registering Transaction Server

FIG. 19 illustrates a registering transaction server according to exemplary embodiments of the present invention. The registering transaction server may be implemented by any system having a registration module and may be applied the first to tenth exemplary embodiments.

The native language Internet address system may further comprise a registering transaction server 6322. The registering transaction server 6322 serves to enable a registration module of a language- or region-specific native language address system to temporarily store a registration content and then provide it to a database. The registering transaction server 6322 may serve as a stabilization device that provides separation during a certain time if query congestion occurs or the native language database has troubles when a registration request is directly delivered to the native language Internet address database. Preferably, the request is reflected to the database in real time or at a time in a specific time. The registering transaction server 6322 communicates with the respective NLIA systems to perform processing, thereby allowing more efficient management.

For example, to perform registration from one NLIA system to another NLIA system, the registering transaction server 6322 requests the registration module of another NLIA system to confirm whether registration is done or not, and provides the result to a registration requester. If the requester requests registration, the request is sent to another NLIA service registration system so that the registration is performed.

Configuration of a Transaction Server and a Central Database Server

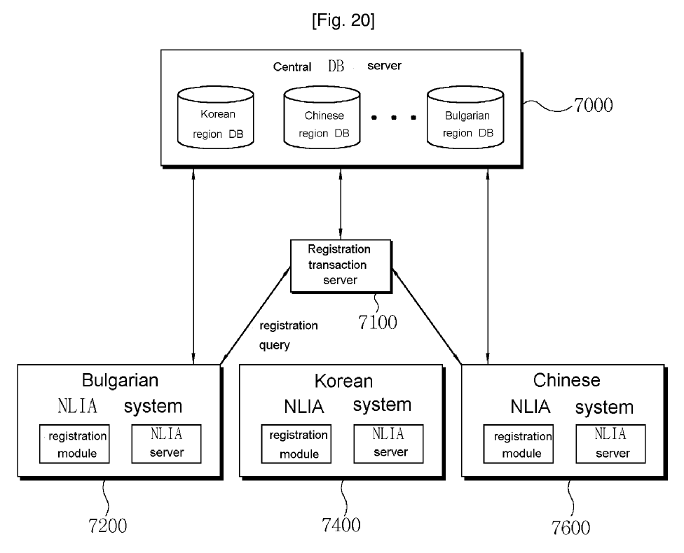

FIG. 20 illustrates a configuration of a transaction server and a central database server according to exemplary embodiments of the present invention. A distributed central database server may be implemented in any system having a central database and applied to fourth, fifth, ninth and tenth exemplary embodiments.

Referring to FIG. 20, NLIA systems 7200, 7400 and 7600 are each connected to a central database server 7000 and a transaction server 7100. The central database server 7000 may store both language- and region-specific NLIA databases.

The region-specific NLIA database will be described by way of example. When each region-specific NLIA system needs an NLIA database of another region or its own region, it performs retrieval through the central database server 7000 and receives the retrieval result. The transaction server 7100 performs a registration function. Upon the retrieval responsive to the query other than the registration, each region NLIA system directly connects to the central database server 7000 not via the transaction server 7100. For example, if a Korean NLIA system sends a request for a response to a query of “SAMSUMG” within a Korean region, the request is directly delivered to the central database server 7000 not via the transaction server 7100, and the central database server 7000 performs retrieval on the Korean region database and delivers the retrieval result to the Korean NLIA system.

With this scheme, the transaction server 7100 is able to connect to the native language system of each region, and calculates and bills costs upon native language registration, and is able to separately carry out a registration task and other tasks, thereby constructing more efficient system.

Meanwhile, each of the central database server and the transaction server may be configured in a distributed structure having a copy server storing the same content in several regions. It is possible to implement an overall system by using the registering transaction server. In the distributed server, query and response are sent to and received from a regional server providing the fastest response. Each regional system may be connected to the distributed central database server, the transaction server, and the registering transaction server in an anycast scheme.

Temporary Storage

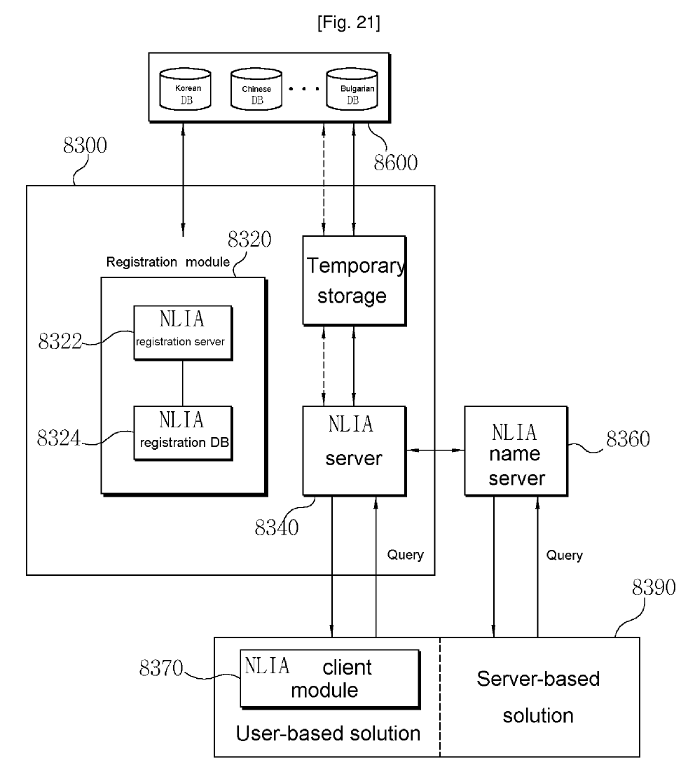

FIG. 21 illustrates a temporary storage according to exemplary embodiments of the present invention. The temporary storage may be implemented in any system having a central database server 8600 and applied to the fourth, ninth and tenth exemplary embodiments.

The temporary storage is a kind of a cache memory and functions to temporarily store a value from the central database server 8600 and to respond this function when the same request is sent from the native language Internet address server 8340.

Client Module Scheme and Server-Based Scheme

FIG. 21 illustrates a client module scheme and a server-based scheme according to exemplary embodiments of the present invention. The client module scheme and the server-based scheme are applicable to the first to tenth exemplary embodiments.

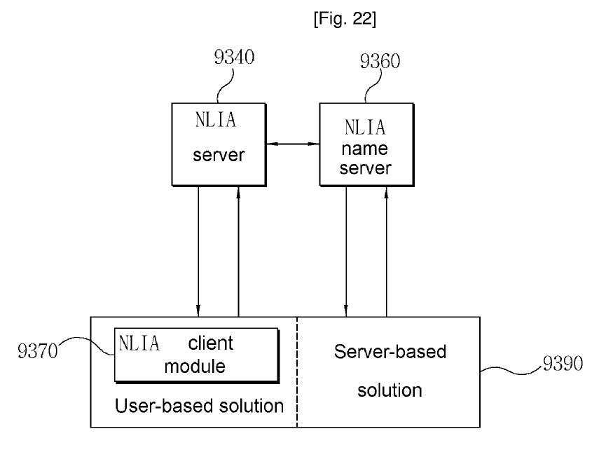

Referring to FIG. 22, a client connecting to the NLIA system is operable in a server-based solution scheme. Alternatively, the client is operable as an NLIA client module 9370 having native language Internet address user software installed in the client to provide system extension and another protocol support.

The NLIA client module 9370 determines if user-input data is an English language domain name or a native language domain name. If it is the native language domain name, the NLIA client module 9370 delivers the native language name to the NLIA server 9340, receives a result value and sends the result value to the client 9390. The NLIA client module 3370 communicates data by means of TCP/IP socket communication on HTTP.

The client 9390 operating in the server-based solution delivers a user-input query to the NLIA name server 9360. The NLIA name server 9360 determines if the query is an English language domain name or a native language domain name and, when it is the native language domain name, delivers the query to the NLIA server 9340.

Region-Specific Database-Based Native Language Internet Address Service Method

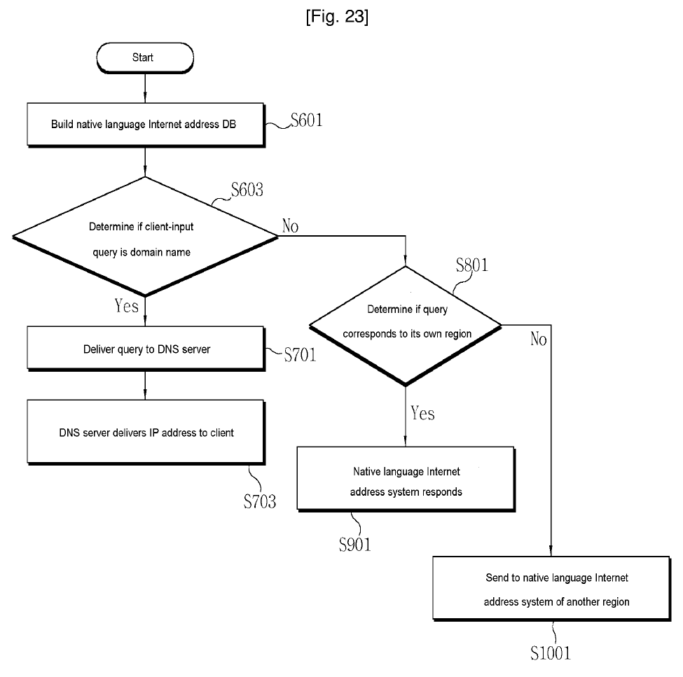

A native language Internet address service method according to an exemplary embodiment of the present invention will be described in detail with reference to FIG. 23. FIG. 22 is a flowchart illustrating a native language Internet address service method according to an exemplary embodiment of the present invention.

Native language Internet address data is first registered to build a region-specific native language Internet address database (S101).

When a client inputs a query, it is determined if the query is an English language domain or not (S103). An identifier indicating a region may be added to the query. Specifically, for example, an identifier “#82” is appended to the “query.” Letters subsequent to “#” is an identifier indicating a region. A numeral is imparted to each region, e.g., country and appended subsequent to the query. In fact, a user may input a query and an identifier together. Alternatively, a user selects a region and inputs a query using a program configured to select a region identifier in a scroll scheme, and the program creates an identifier corresponding to the region (e.g., #82 described above). For example, in the case where a user directly inputs a query of SAMSUNG#82, when #82 is pre-specified to indicate a Korea region, a native language Internet address system in any region directly connects to a Korean Internet address system to deliver a query of “SAMSUNG.”

When the query is a domain, the native language Internet address system delivers the query to the DNS server (S701). In response to receiving the query, the DNS server sends an IP address to the client (S703). When the query is not a domain, the native language Internet address system delivers the query to the native language Internet address system.

If the query is not a typical domain, the native language Internet address system determines if the query is a request for service of its own region or a request for service of other region (S801). For example, in Korea, all languages such as Korean, English, etc. are stored in a native language Internet address database server of the native language Internet address system. Accordingly, if the query is a request for service of its region, the query is sent to the Korean native language Internet address system and the Korean native language Internet address system responds to the query (S901). However, when the input query is a request for other region service, the query is sent to a native language Internet address system in other region (S1001). Preferably, a determination as to whether the query is related to its region or not is based on region information added to the native language.

Meanwhile, it is problematic to process queries that are registered in native language Internet address systems of other regions. For this non-registered query, i) the query may be delivered to an NLIA database server (i.e., native language Internet address system) of a pre-specified region, ii) a retrieval result may be sent in association with a retrieved site, and iii) a similar value from NLIA database servers of all regions may be searched and notified.

While an exemplary embodiment of the present invention has been shown and described, it will be appreciated by those skilled in the art that various changes, and modifications can be made without departing from the spirit and scope of the invention defined by the appended claims and their equivalents.

### INDUSTRIAL APPLICABILITY

As described above, a native language Internet address system of the present invention is capable of indicating data accessible to a specific resource by using a keyword written in a language of each country, and allows a user to access information such as web, mail, telephone and fax through a native language, unlike an existing hierarchical domain written in Letter, Digit, Hyphen (LDH).

This system is also able to support data of a variety of languages and countries. Corresponding servers can communicate data from the same standpoint, not hierarchical branches from a root of a domain, and use UCS transformation format (UTF) letter language such that letters/characters of the world that can be represented in Unicode are all processed.

Further, it is possible to provide native language Internet address service in which intelligent searching is possible discovering a corresponding value through communication between country-specific native language Internet address systems using a variety of country and language features.

Native language Internet address systems of respective countries are cooperated by using a native language Internet address communication channel, such that native language Internet addresses of one country are available to other countries.

1-38. (canceled)

39. A native language Internet address system classified by languages and connected to a central native language Internet address database server comprising a native language Internet address database server in each region, said system comprising:
a native language Internet address registration module connected to the central native language Internet address database server for registering the native language Internet address data of its region; and
a native language Internet address server connected to the central native language Internet address database server for sending a query input by a client to the central native language Internet address database server and receiving a corresponding URI or URL address from the central native language Internet address database server, wherein the central native language Internet address database server identifies a type of a language representing the input query and retrieves a URI or URL address corresponding to the language.

40. The system according to claim 39, wherein region information is added to the query.

41. The system according to claim 40, wherein the region information in the query is identified by a language tag selected in a browser.

42. The system according to claim 39, wherein the central native language Internet address database server comprises at least two distributed structures.

43. The system according to claim 39, further comprising a registering transaction server before the registration module.

44. The system according to claim 39, wherein the central database server is divided into one or more portions and the system comprises a separate transaction server.

45. The system according to claim 39, further comprising a temporary storage for temporarily storing a value carried by the native language Internet address.

46. The system according to claim 39, wherein the client inputs a query in a client module scheme or server-based scheme.

47. The system according to claim 39, further comprising a native language Internet address name server connected to the native language Internet address server.

48. A native language Internet address service method, comprising:
registering native language Internet address data to build a native language Internet address database;
when a query is input by a client, determining if the query is written in a native language serviced in a region or a language of another region; and
when the input query is written in the native language, fetching a URI or URL address corresponding to the native language from the native language Internet address database server and, when the input query is written in the language of another region, fetching a URI or URL address corresponding to the query in cooperation with a native language Internet address service system in another region.

49. The method according to claim 48, wherein the region information in the query is identified by a language tag selected in a browser.

50. A native language Internet address system, comprising:
a native language Internet address database server for receiving and storing native language Internet address data written in languages of relevant regions;
a native language Internet address registration module connected to the native language Internet address database server for registering the native language Internet address data; and
a native language Internet address server connected to the native language Internet address database server for delivering a query input by a client to the native language Internet address database server and receiving a corresponding URI or URL address from the native language Internet address database server,
wherein the native language Internet address system communicates with native language Internet address systems composed of languages of other regions in cooperation with the native language Internet address systems in response to a client's request.

51. The system according to claim 50, which is connected to the native language Internet address system in the other region via a transaction server.

52. A central native language Internet address database server for use in a native language Internet address system, the system comprising a native language Internet address registration module for registering region-specific native language Internet address data; and a native language Internet address server that delivers a query input by a client to the central native language Internet address database server and receives a corresponding URI or URL address, wherein the central native language Internet address database server retrieves a URI or URL address corresponding to region information added to the input query and delivers the address to the native language Internet address server.

53. The central native language Internet address database server according to claim 52, comprising at least two distributed structures.

54. A native language Internet address service method, comprising:
registering native language Internet address data of one region to build a native language Internet address database;
when a query is input by a client, determining if the query is a request for service of the region or a request for service of another region; and
when the input query is the request for service of the region, fetching a URI or URL address corresponding to the native language from the native language Internet address database and, when the input query is the request for service of another region, fetching a URI or URL address corresponding to the query in cooperation with a native language Internet address service system in another region.

55. The method according to claim 54, wherein region information is added to the query.
